(19) United States
(12) Patent Application Publication
(10) Pub. No.: US 2019/0022615 A1
(43) Pub. Date: Jan. 24, 2019

(54) CLOVERLEAF MIXER-HEAT EXCHANGER

(71) Applicant: BASF SE, Ludwigshafen am Rhein (DE)

(72) Inventors: Faissal-Ali EL-TOUFAILI, Ludwigshafen am Rhein (DE); Cornelia KERMER, Ludwigshafen am Rhein (DE); Gledison FONSECA, Ludwigshafen am Rhein (DE)

(73) Assignee: BASF SE, Ludwigshafen am Rhein (DE)

(21) Appl. No.: 16/072,048

(22) PCT Filed: Jan. 27, 2017
(86) PCT No.: PCT/EP2017/051814

§ 371 Date: Jul. 23, 2018

(30) Foreign Application Priority Data
Jan. 29, 2016 (EP) 16153384.9

(51) Int. Cl. B01F 15/06; B01F 5/06

(52) U.S. Cl. CPC B01F 15/066; B01F 2015/062; B01F 5/061

(57) ABSTRACT

A mixer/heat exchanger insert or mixer/heat exchanger having a geometry which leads to less fouling of a fluid to be temperature-controlled.

### FIELD OF THE INVENTION

The present invention relates to a mixer/heat exchanger insert and to a mixer/heat exchanger, in particular to a mixer/heat exchanger insert and to a mixer heat/exchanger with a reduced tendency for fouling.

### BACKGROUND OF THE INVENTION

Both static and dynamic mixers can be used for mixing fluids. In the case of dynamic mixers, use can be made, for example, of stirring elements which actively stir the fluid to be mixed. In the case of a static mixer, mixing is accomplished not by externally introduced stirring energy but by the energy which is inherent in a flowing fluid. In this case, the fluid is mixed by the movement of the fluid as it impinges upon a mixer geometry. For mixing of this kind by means of a static mixer, “X mixers” are used, for example, in which structures that are arranged in alternation transversely to one another and mix a fluid flowing through are inserted in the flowing volume. “X mixers” of this kind can consist of a multiplicity of rod-shaped flat elements, for example, which are arranged alternately, for example, e.g. at an angle of 90° to one another. In this way, a fluid flowing through it is split and recombined again several times, leading to laminar or turbulent flow, or is forced to change direction, thereby causing turbulent flow, which then leads to mixing of the fluid.

Since mixers of this kind are often used in reactors, there is furthermore the necessity not only to mix the fluid but also to simultaneously control the temperature of the fluid. For this purpose, mixers/heat exchangers consisting of a plurality of tubes through which a temperature control liquid can be passed are known. Here, these tubes, which generally extend in the longitudinal direction of a flow duct, are provided with baffles arranged transversely thereto, which bring about mixing of the fluid flowing through by “split and recombine”.

The prior art furthermore includes heat exchangers in which the tubes carrying a temperature control fluid are routed in a meandering shape, wherein the tubes routed in a meandering shape are situated in a plane parallel to the direction of flow of the fluid in a flow duct.

The mixers and heat exchangers described above are known from EP 1 067 352 A2 or WO 2008/017571 A1, for example.

The heat exchangers or mixers described above have only a low mixing capacity or, especially in the case of fluids which contain agglomerates, tend to accumulation of the agglomerates in regions with acute angles, in which the agglomerates or thickened fluid lumps can stick, or have regions in which the flow is calmed, in which secondary reactions can take place, the products of which can likewise settle. This effect is referred to as fouling.

Such fouling may have a negative effect on the state of the fluid requiring mixing and temperature control, and therefore settling of agglomerates or thickened fluid lumps should be avoided.

### SUMMARY OF THE INVENTION

It can be regarded as an object of the present invention to provide a mixer/heat exchanger insert and a mixer/heat exchanger having a reduced tendency for fouling.

The object of the present invention is achieved by a mixer/heat exchanger insert or a mixer/heat exchanger as claimed in one of the independent claims, wherein the illustrative embodiments are embodied in the dependent claims.

According to one embodiment of the invention, a mixer/heat exchanger insert is provided having an extent in a longitudinal direction of extent, comprising a temperature control fluid inlet, a temperature control fluid outlet, and a volume for carrying a temperature control fluid, which volume extends between the temperature control fluid inlet and the temperature control fluid outlet and has a first tubular section, wherein the tubular section extends in the longitudinal direction of extent, wherein the tubular section is routed in loops transversely to the longitudinal direction of extent.

In this way, it is possible to provide a mixer/heat exchanger insert, especially for use in a mixer/heat exchanger, which, by virtue of the loop formation, has a good mixing behavior and furthermore also has good heat exchanger characteristics. Particularly through the routing of the tubular section in loops, wedge-shaped angles and sharp-edged pinch points, in which thickened portions or lumps of a liquid to be temperature-controlled can settle, can be avoided. These settled lumps or thickened portions can lead to a change in the morphology of the lumps or thickened portions since they are in the mixer/heat exchanger for a relatively long time, with the result that a “fouling” process can occur.

According to one embodiment of the invention, the loops are routed in such a way around at least three axes extending in the longitudinal direction of extent L that they each form loop eyes, which are situated on one of the axes extending in the longitudinal direction of extent and can enclose a further, straight tubular section of the volume extending in the longitudinal direction of extent L.

By means of the multiple formation of loops, it is possible in this way to achieve a good mixing process, and additional tube sections can be passed through the eyes formed by the loops, which are arranged in series. In this way, improved temperature control behavior can be produced. Furthermore, the provision of a corresponding pipe through the loop eyes arranged in series allows a return path of the tubular section, thus allowing both a temperature control fluid inlet and a temperature control fluid outlet to be provided at the same end in relation to the longitudinal direction of extent L.

According to one embodiment of the invention, the first tubular section extends continuously in the longitudinal direction of extent L.

In this way it is possible to avoid a situation where thickened portions or lumps of a liquid to be temperature-controlled or of a fluid to be temperature-controlled can settle. In particular, it is possible to avoid a situation where the elongated lumps or strands of thickened material can catch on protrusions in the direction of longitudinal extent without the possibility of their being taken along by a fluid flow of the liquid to be temperature-controlled. Moreover, it is possible, by avoiding return paths of the tubular section in relation to the longitudinal direction of extent L, to provide a more efficient heat exchanger geometry since in this way the loops of the tubular section can be wound in a manner which saves more space.

According to one embodiment of the invention, as they extend around at least three axes extending in the longitudinal direction of extent L, the loops are routed without alternating curvature between two axes in each case.

In this way, at least three passages can be provided for tubular sections extending in the longitudinal direction, these being formed by the loop eyes situated in series. In this case, it is a relatively simple matter to produce a mixer/heat exchanger insert without alternating curvature between the loops since the tubular section can be bent repeatedly in the same way.

According to one embodiment of the invention, as they extend around at least three axes extending in the longitudinal direction of extent L, the loops are routed with alternating curvature between two axes in each case.

By embodying the tubular section with alternating curvature, it is possible to produce the mixer/heat exchanger insert substantially without stress since the respectively successive curvatures are compensated by the alternating direction of curvature, thereby making it possible to achieve increased accuracy of production.

According to one embodiment of the invention, a U-shaped tube section is provided, in which the two legs of the U are each passed through the successive loop eyes, wherein the first tubular section and the U-shaped tube section are arranged fluidically in parallel and can receive a flow of the temperature control fluid separately or jointly via a common flange.

According to one embodiment of the invention, the mixer/heat exchanger insert furthermore has a second, straight tubular section extending in the longitudinal direction of extent, which is connected fluidically in series with the first tubular section and passes through the loop eyes situated on a first axis extending in the longitudinal direction of extent.

In this way, the temperature control fluid flow can be returned at the end of the mixer/heat exchanger insert, thus allowing a temperature control fluid inlet and a temperature control fluid outlet to be arranged at the same end of the mixer/heat exchanger insert.

According to one embodiment of the invention, the mixer/heat exchanger insert furthermore has a third, straight tubular section extending in the longitudinal direction of extent L and a fourth, straight tubular section extending in the longitudinal direction of extent L, which are connected fluidically in series with the first tubular section and the second tubular section, wherein the third tubular section passes through the loop eyes situated on a second axis extending in the longitudinal direction of extent, and the fourth tubular section passes through the loop eyes situated on a third axis extending in the longitudinal direction of extent.

In this way, an additional length of a tubular section can be provided, thereby improving the temperature controlling effect of the mixer/heat exchanger insert by virtue of the enlarged surface area and the increased length of the overall tubular sections.

According to one embodiment of the invention, the third tubular section and the fourth tubular section each form one leg of a U tube.

In this way, the temperature control fluid, after flowing through the loop-shaped arrangement of the first tubular section, can be carried once again in the longitudinal direction of extent, thereby producing a significant increase in the length of the overall tubular sections.

According to one embodiment of the invention, as they extend around five axes extending in the longitudinal direction of extent, the loops are routed without alternating curvature between two axes in each case.

Through retention of the direction of curvature, it is possible in this way to achieve simple production of a mixer/heat exchanger insert, wherein the embodiment of a loop pattern around five axes extending in the longitudinal direction of extent provides an efficient mixer arrangement which furthermore also has good heat exchanger characteristics.

According to one embodiment of the invention, as they extend around five axes extending in the longitudinal direction of extent, the loops are routed with alternating curvature between two axes in each case.

By means of the alternating direction of curvature, it is possible to compensate stress during the production of the tubular section by means of the alternating curvature, whereby the loop around five axes extending in the longitudinal direction of extent results in an optimized mixer characteristic, which furthermore also has good heat exchanger characteristics.

According to one embodiment of the invention, the mixer/heat exchanger insert furthermore has a fifth tubular section extending in a straight line in the longitudinal direction of extent L and a sixth tubular section extending in a straight line in the longitudinal direction of extent L, which are connected fluidically in series with the first tubular section and the second tubular section and pass through the loop eyes situated on a fourth axis extending in the longitudinal direction of extent L and through the loop eyes situated on a fifth axis extending in the longitudinal direction of extent L.

In this way, optimum use can be made of the space formed by the eyes since, especially where the first tubular section is wound around five axes extending in the longitudinal direction of extent, each of the five spaces thereby formed is filled by a further tubular section, thereby making it possible to increase the total length of the tubular sections and thus to achieve an improved heat exchanger ratio. It should be understood that the fifth and sixth tubular sections do not necessarily have to be connected directly to the second, third and fourth tubular sections.

According to one embodiment of the invention, the tubular section has a tube path pattern in which, with respect to axes A, B, C, D and E arranged in the longitudinal direction at the corners of a pentagram, in particular a regular pentagram, the tubular section extends along the points A1, A2, B2, B1, C1, C2, D2, D1, E1, E2, A2, A1, B1, B2, C2, C1, D1, D2, E2, E1, A1 . . . , counterclockwise in relation to points A1, B1, C1, D1 and E1 situated offset relative to the axes, as shown in FIG. 9, and clockwise in relation to points A2, B2, C2, D2 and E2 situated offset relative to the axes, as shown in FIG. 9.

In this way, a regular winding pattern of the first tubular section can be provided, in which, as they extend around five axes extending in the longitudinal direction, the loops are routed with alternating curvature between two axes in each case.

According to one embodiment of the invention, a mixer/heat exchanger is provided which has a fluid-carrying volume having a fluid inlet and a fluid outlet, and a mixer/heat exchanger insert in accordance with the above description, wherein the mixer/heat exchanger insert extends into the fluid-carrying volume, with the result that a fluid flowing into the fluid-carrying volume through the fluid inlet is subject to a shear stress owing to the geometry of the mixer/heat exchanger insert before the inflowing fluid leaves the fluid-carrying volume through the fluid outlet.

In this way, it is possible to provide a mixer/heat exchanger having an above-described mixer/heat exchanger insert, which has good mixing behavior as a static mixer and good heat exchanger behavior.

According to one embodiment of the invention, the fluid-carrying volume has a constant clear cross-sectional area in the longitudinal direction of extent L.

In this way, the mixer/heat exchanger insert can reliably fill the fluid volume without the formation of critical constrictions that favor fouling behavior. It is furthermore possible to avoid the formation of elongated flow volumes with large cross sections, which would allow a fluid that requires mixing and temperature control to pass through the mixer/heat exchanger, in particular laterally, without having undergone sufficient mixing or temperature control.

According to one embodiment of the invention, an envelope of the mixer/heat exchanger insert in accordance with the above description has a clearance with respect to an inner wall of the fluid-carrying volume of the mixer/heat exchanger, into which the mixer/heat exchanger insert is to be introduced, which is at least a quarter of the tube diameter.

In this way, it is possible to avoid the settling of lumps or thickened portions of a fluid to be temperature-controlled at the constrictions between the mixer/heat exchanger insert and the inner wall of the fluid-carrying volume of the mixer/heat exchanger.

The individual features as described above can of course also be combined with one another, thereby making also making it possible in some cases to obtain advantageous effects which go beyond the sum of the individual effects.

These and other aspects of the present invention are explained and clarified through reference to the illustrative embodiments described below.

### BRIEF DESCRIPTION OF THE DRAWINGS

Illustrative embodiments are described below with reference to the following drawings.

FIG. 1 shows a plan view of an illustrative embodiment of a mixer/heat exchanger insert viewed from the temperature control fluid inlet and temperature control fluid outlet.

FIG. 2 shows a plan view of an illustrative embodiment of a mixer/heat exchanger insert from the side facing away from the temperature control fluid inlet and the temperature control fluid outlet.

FIG. 3 shows a side view of an illustrative embodiment of a mixer/heat exchanger insert.

FIG. 4 shows another illustrative embodiment of a mixer/heat exchanger insert having two tubular sections of U-shaped configuration.

FIG. 5 shows an illustrative embodiment of a mixer/heat exchanger insert without tubular sections passed through the eyes.

FIG. 6 shows an illustrative embodiment of a mixer/heat exchanger insert with five tubular sections passed through the eyes of the loops.

FIG. 7 shows a partially sectioned view of an illustrative embodiment of a mixer/heat exchanger insert in which the temperature control fluid inlet and the temperature control fluid outlet are situated at opposite ends.

FIG. 8 shows a partially sectioned view of an illustrative embodiment of a mixer/heat exchanger insert in which the temperature control fluid inlet and the temperature control fluid outlet are situated at the same end.

FIG. 9 shows a winding pattern of the loops in accordance with an illustrative embodiment of the invention in which the loops are routed with alternating curvature between two axes.

FIG. 10 shows an illustrative embodiment of a winding pattern around five axes, in which the loops are routed without alternating curvature.

FIG. 11 shows an illustrative embodiment of a winding pattern around three axes, in which the loops are routed without alternating curvature.

### DETAILED DESCRIPTION OF ILLUSTRATIVE EMBODIMENTS

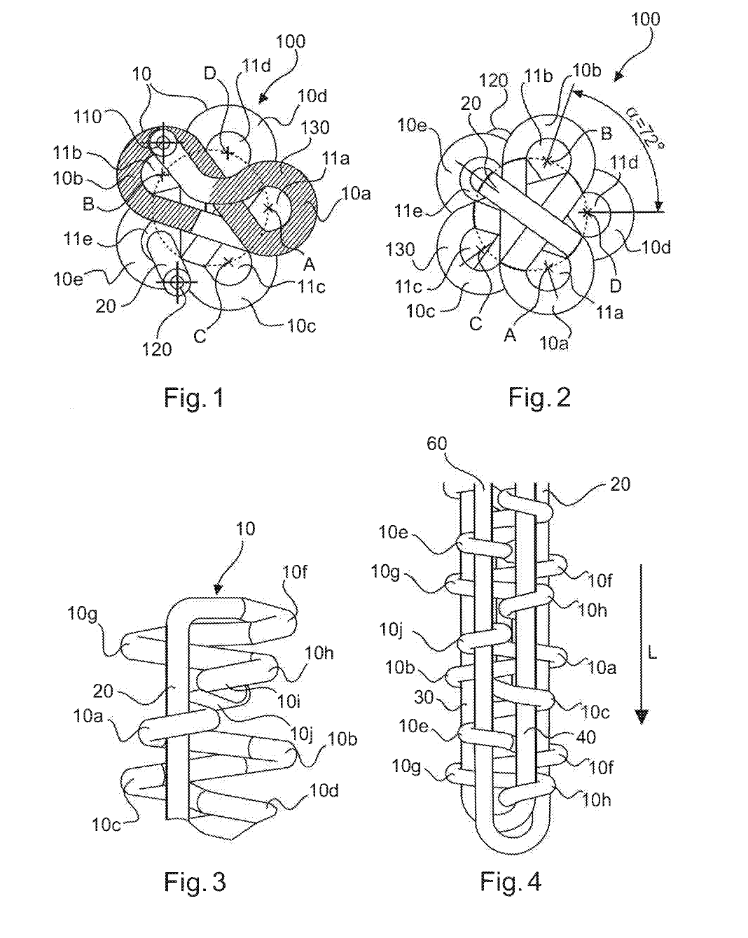

FIG. 1 shows an illustrative embodiment of a mixer/heat exchanger insert 100, which has an extent in a longitudinal direction of extent L. FIG. 1 shows the mixer/heat exchanger insert 100 as viewed in the longitudinal direction of extent L. The mixer/heat exchanger insert 100 has a volume in which a temperature control fluid is carried. This volume extends between a temperature control fluid inlet 110 and a temperature control fluid outlet 120. The volume has a first tubular section 10, wherein the tubular section 10 extends in the longitudinal direction, although this cannot be seen in FIG. 1 owing to the view in the longitudinal direction of extent L. In this arrangement, the tubular section 10 is routed in loops, in this case around the axes A, C, E, B, D distributed uniformly along a circular arc in the longitudinal direction. Here, the loops form loop eyes around the respective axes, wherein loop 10a is routed around axis A and, in the process, forms loop eye 11a. Similarly, the tubular section is routed in a loop around axis B as a second loop 10b and, in the process, forms loop eye 11b. The winding pattern continues similarly around axes C, D and E. In this arrangement, the first tubular section 10 begins with the temperature control fluid inlet 110 and ends at the opposite end from the observer, wherein the second tubular section 20 is then connected fluidically in series to the first tubular section 10 at the opposite end from the observer and ends here in the temperature control fluid outlet 120. It should be understood here that the flow through the arrangement can also take place in the opposite direction of flow, as a result of which the temperature control fluid inlet 120 serves as an inflow for the temperature control fluid, which flows out again through the temperature control fluid outlet 110.

FIG. 2 shows the mixer/heat exchanger insert 100 of FIG. 1 from the end facing away from the observer in FIG. 1. Here, the reference signs are used analogously. From FIG. 2, it can be seen that the axes A, C, E, B, D are each arranged offset by an angle α=72° along a circular arc and are thus distributed regularly along the circular arc. Here, the axes form the corners of a regular pentagram in the plan view shown in FIG. 2.

FIG. 3 shows a side view of the mixer/heat exchanger insert 100 shown in FIG. 1 and FIG. 2. From FIG. 3, it can be seen that the first tubular section 10 is adjoined by the second tubular section 20, which is here passed through the eye of loop 10a. Here, the winding pattern is repeated after passing twice around each of the axes.

FIG. 4 shows a side view of an end piece of a mixer/heat exchanger insert 100, in which respective further straight tube sections 20, 30, 40, 60 are passed through the respective eyes of the loops 10a-10j. Here, it can be seen from FIG. 4 that the second tubular section 20 is passed through loops 10f and 10a, the third tubular section 30 is passed through loops 10b and 10g, the fourth tubular section 40 is passed through loops 10c and 10h, and the sixth tubular section 60 is passed through loops 10e and 10j. The fifth tubular section 50, which is not visible in FIG. 4, would then be passed through loops 10d and 10i. From FIG. 4, it can be seen that the second tubular section 20 and the sixth tubular section 60 are connected in a U shape, with the result that the second tubular section and the sixth tubular section each form one leg of a U. Similarly, the fourth tubular section 40 and the third tubular section 30 are likewise connected in a U shape, with the result that the third tubular section 30 and the fourth tubular section 40 likewise form one leg of a U. Although not shown in FIG. 4, the second tubular section 20 and the fourth tubular section 40 can likewise be connected, at the end of the mixer/heat exchanger insert which is not shown here, in a U shape, for example, with the result that the straight tubular sections 20, 30, 40, 50 and 60 meander through the eyes of the first tubular section 10, which lie one above the other. Likewise, the third and fourth tubular sections and/or also the fifth and sixth tubular sections could be connected in a U shape.

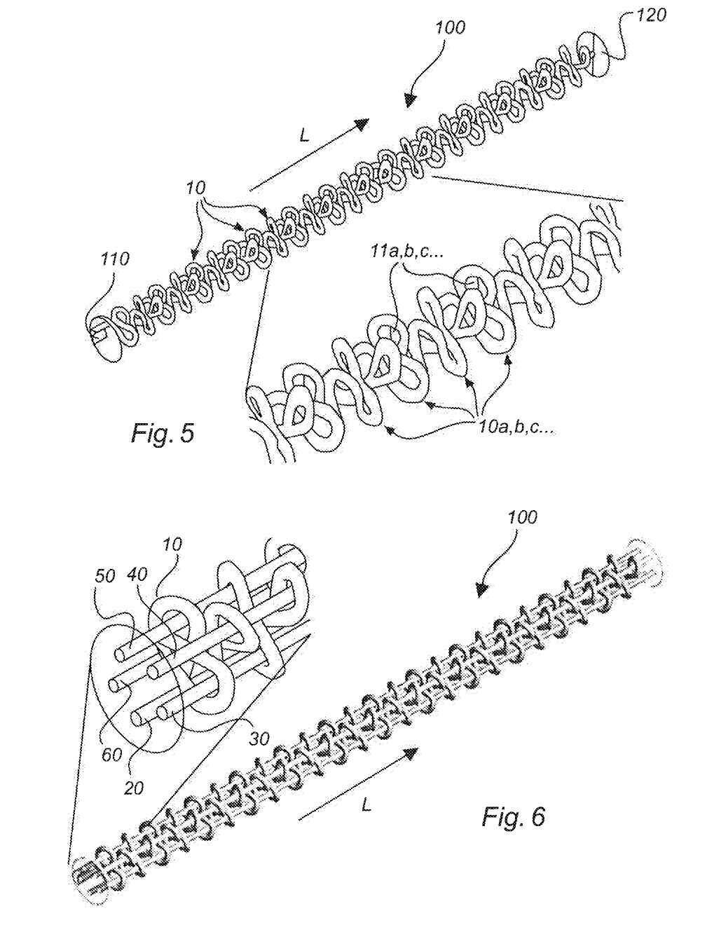

FIG. 5 shows a perspective view of a mixer/heat exchanger insert 100. In this case, the mixer/heat exchanger insert shown in FIG. 5 has only a first tubular section 10, which is routed in loops. Here, the loops form eyes lying one above the other, although no further straight tubular section is passed through said eyes in FIG. 5. A mixer/heat exchanger insert 100 of this kind can then be inserted into a corresponding tube, which is sealed off by end plates, for example, through which a corresponding temperature control fluid inlet 110 and a temperature control fluid outlet 120 are guided. Here, there is a continuous flow from one end to another end of a mixer/heat exchanger insert of this kind.

FIG. 6 shows a mixer/heat exchanger insert 100 in accordance with another embodiment of the invention, although, in this insert, further straight tubular sections are passed through the eyes formed by the loops. These can all end at the end plate, for example, as can be seen in the enlarged view. This also applies analogously to the opposite end. However, it should be understood that the mixer/heat exchanger insert 100 shown in FIG. 6 can be modified in such a way that the corresponding temperature control fluid inlets and outlets are connected to one another by U-shaped bends in such a way that there is serial flow through the first tubular section 10 routed in loops and the respective straight tubular sections 20, 30, 40, 50, 60.

FIG. 7 shows an illustrative embodiment of a mixer/heat exchanger 200 in accordance with one illustrative embodiment. The mixer/heat exchanger insert shown in FIG. 7 has a fluid-carrying volume 230, into which a fluid that requires temperature control and mixing is introduced through a fluid inlet 210, which fluid leaves the mixer/heat exchanger again through the fluid outlet 220. The mixer/heat exchanger shown in FIG. 7 has a temperature control fluid inlet 110 at one end and a temperature control fluid outlet 120 at the opposite end. In the interior of the mixer/heat exchanger 200, in particular in the interior of the fluid-carrying volume 230, there is the mixer/heat exchanger insert 100, which has already been described in detail with reference to FIGS. 1 to 6. It should be understood that the fluid to be temperature-controlled can flow through the mixer/heat exchanger 200 substantially in the same direction as the temperature control fluid flows through the mixer/heat exchanger insert 100. However, the temperature control fluid can likewise also flow in a countercurrent through the mixer/heat exchanger insert.

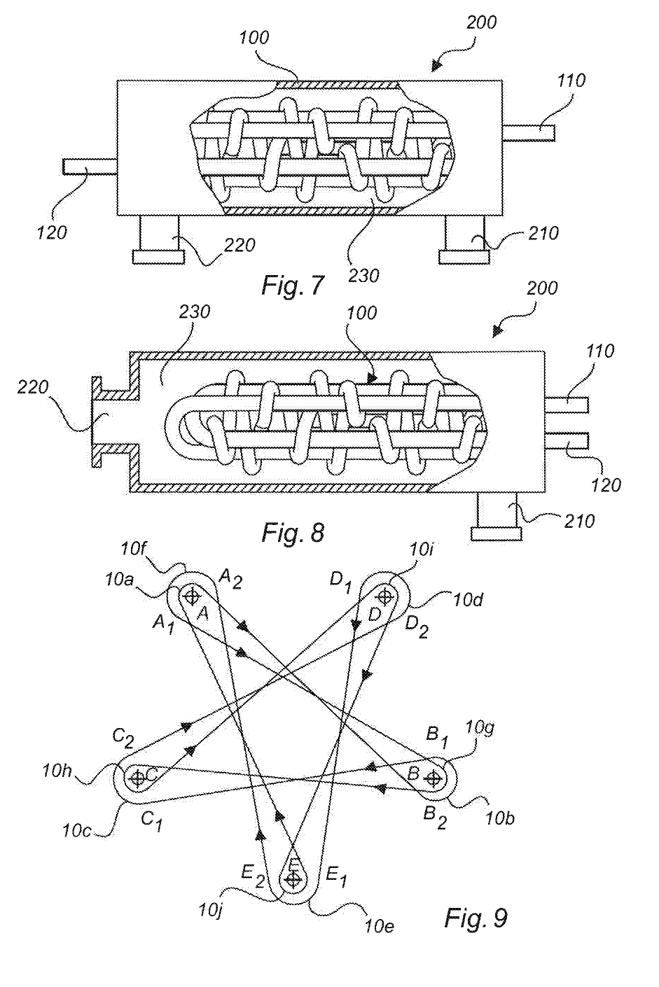

FIG. 8 shows another illustrative embodiment of the invention, in which the mixer/heat exchanger insert has a temperature control fluid inlet 110 and a temperature control fluid outlet 120 at the same end. As a departure from FIG. 7, the fluid outlet 220 can then also be arranged on the longitudinal axis or end since no temperature control fluid inlet or outlet is arranged in this region.

FIG. 9 shows a winding path in accordance with an illustrative embodiment of the invention in which the loops are routed around the corresponding axes A, C, E, B and D. Here, the sides offset clockwise from the axes shall be provided with the index 2 and those offset counterclockwise shall be provided with the index 1. According to this pattern, the first tubular section having loops 10a, 10b, 10c, 10d, 10e, 10f, 10g, 10h, 10i, 10j is wound successively around axes A, B, C, D and E, more specifically passing around them twice. Here, it can be seen from the winding pattern shown in FIG. 9 that, after each pass around an axis, the curvature of the first tubular section is in a different direction. In this way, the directions of curvature alternate after each pass around an axis. The winding pattern formed during this process is repeated after two passes around each axis in accordance with the pattern shown in FIG. 9. Here, the sides of the axes follow the pattern A1, A2, B2, B1, C1, C2, D2, D1, E1, E2, A2, A1, B1, B2, C2, C1, D1, D2, E2, E1, A1 . . . around the axes A, B, C, D and E. It should be understood that this winding pattern can also be inverted and that an inverted arrangement is also included in the scope of protection.

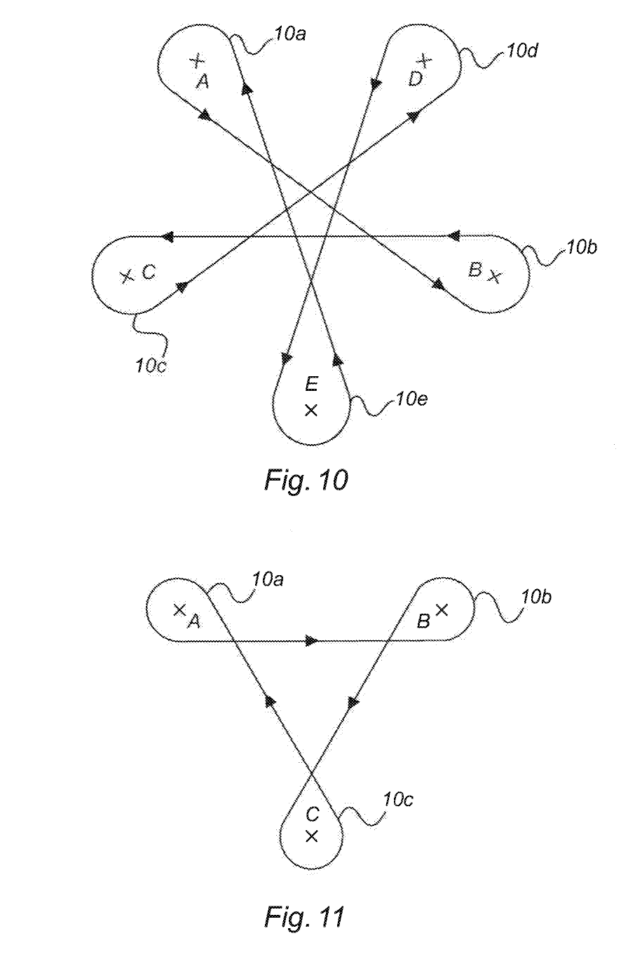

FIG. 10 shows an alternative winding pattern, in which loops 10a, 10b, 10c, 10d and 10e of the first tubular section are routed around the axes A, B, C, D and E without alternation of the direction of curvature. Here, it can be seen from FIG. 10 that the direction of curvature does not change. Figuratively speaking, when driving along this winding line, the steering has only ever to be turned in one direction, in this case to the left. In contrast, it was necessary, figuratively speaking, to turn the steering in the other direction after coming around each axis when driving along the winding pattern shown in FIG. 9. From FIG. 10, it can be seen that this winding pattern, in which the curvature does not alternate but is always in the same direction, is repeated after a single pass around each axis.

FIG. 11 shows another illustrative embodiment of the invention, in which the loops of the first tubular section are wound around just three axes, wherein the curvature does not alternate but is always in one direction. As an alternative, it is also possible with three axes to use a winding pattern (not shown) in which the direction of curvature changes between two axes in one pass. Similarly to the nomenclature in reference to FIG. 9, this pattern would be A1, A2, B2, B1, C1, C2, A2, A1, B1, B2, C2, C1, A1 . . .

It should be understood that the invention described above can be used as a mixer/heat exchanger. A typical use for this is in a reactor, for example, in which mixing and temperature control is desired. By means of the abovementioned invention, a sufficient mixing effect can be achieved and agglomeration of particles or highly viscous gel particles can be avoided or at least minimized. It is thereby possible to reduce or avoid a fouling effect. A mixer/heat exchanger insert in accordance with the invention described above is suitable, in particular, for allowing it to be introduced into particularly small tube diameters while nevertheless achieving a satisfactory heat exchanger characteristic and adequate mixing behavior.

It should be noted that the term “comprise” does not exclude further elements or method steps, just as the terms “a” and “an” do not exclude a plurality of elements and steps.

The reference signs used serve merely to enhance comprehensibility and should not be regarded as in any way restrictive, the scope of protection of the invention being given by the claims.

### LIST OF REFERENCE SIGNS

10 first tubular section
10a first loop of the first tubular section
10b second loop of the first tubular section
10c third loop of the first tubular section
10d fourth loop of the first tubular section
10e fifth loop of the first tubular section
10f sixth loop of the first tubular section
10g seventh loop of the first tubular section
10h eighth loop of the first tubular section
10i ninth loop of the first tubular section
10j tenth loop of the first tubular section
11a, 11b, . . . loop eye of the first, second . . . loop
20 second tubular section
30 third tubular section
40 fourth tubular section
50 fifth tubular section
60 sixth tubular section
100 mixer/heat exchanger insert
110 temperature control fluid inlet or outlet
120 temperature control fluid outlet or inlet
200 mixer/heat exchanger
210 (mixing) fluid inlet or outlet
220 (mixing) fluid outlet or inlet
230 (mixing) fluid-carrying volume
L longitudinal direction of extent of mixer/heat exchanger insert
α, alpha pitch angle of the tubular loops in relation to the longitudinal direction of extent L
A, B, C, D, E axes extending in the longitudinal direction of extent L

1.-15. (canceled)

16. A mixer/heat exchanger insert having an extent in a longitudinal direction of extent (L), comprising
a temperature control fluid inlet,
a temperature control fluid outlet,
a volume for carrying a temperature control fluid, which volume extends between the temperature control fluid inlet and the temperature control fluid outlet and has a first tubular section,
wherein the tubular section extends in the longitudinal direction of extent,
wherein the tubular section is routed in loops transversely to the longitudinal direction of extent.

17. The mixer/heat exchanger insert as claimed in claim 16, wherein the loops routed in such a way around at least three axes extending in the longitudinal direction of extent that they each form loop eyes, which are situated on one of the axes extending in the longitudinal direction of extent and can enclose a further, straight tubular section of the volume extending in the longitudinal direction of extent (L).

18. The mixer/heat exchanger insert as claimed in claim 16, wherein the first tubular section extends continuously in the longitudinal direction of extent (L).

19. The mixer/heat exchanger insert as claimed in claim 16, wherein, as they extend around at least three axes (A, B, C) extending in the longitudinal direction of extent (L), the loops are routed without alternating curvature between two axes (A, B; B, C; . . . ) in each case.

20. The mixer/heat exchanger insert as claimed in claim 16, wherein, as they extend around at least three axes extending in the longitudinal direction of extent, the loops are routed with alternating curvature between two axes (A, B; B, C; . . . ) in each case.

21. The mixer/heat exchanger insert as claimed in claim 17, furthermore having a second tubular section extending in a straight line in the longitudinal direction of extent, which is connected fluidically in series with the first tubular section and passes through the loop eyes situated on a first axis (A) extending in the longitudinal direction of extent.

22. The mixer/heat exchanger insert as claimed in claim 21, furthermore having a third tubular section extending in a straight line in the longitudinal direction of extent (L) and a fourth tubular section extending in a straight line in the longitudinal direction of extent (L), which are connected fluidically in series with the first tubular section and the second tubular section, wherein the third tubular section passes through the loop eyes situated on a second axis (B) extending in the longitudinal direction of extent (L), and the fourth tubular section passes through the loop eyes situated on a third axis (C) extending in the longitudinal direction of extent (L).

23. The mixer/heat exchanger insert as claimed in claim 22, wherein the third tubular section and the fourth tubular section each form one leg of a U tube.

24. The mixer/heat exchanger insert as claimed in claim 19, wherein, as they extend around five axes (A, B, C, D, E) extending in the longitudinal direction of extent, the loops are routed without alternating curvature between two axes (A, B; B, C; C, D . . . ) in each case.

25. The mixer/heat exchanger insert as claimed in claim 20, wherein, as they extend around five axes (A, B, C, D, E) extending in the longitudinal direction of extent, the loops are routed with alternating curvature between two axes (A, B; B, C; C, D . . . ) in each case.

26. The mixer/heat exchanger insert as claimed in claim 20, furthermore having a fifth tubular section extending in a straight line in the longitudinal direction of extent (L) and a sixth tubular section extending in a straight line in the longitudinal direction of extent (L), which are connected fluidically in series with the first tubular section and the second tubular section and pass through the loop eyes situated on a fourth axis (D) extending in the longitudinal direction of extent (L) and through the loop eyes situated on a fifth axis (E) extending in the longitudinal direction of extent (L).

27. The mixer/heat exchanger insert as claimed in claim 16, wherein the tubular section has a tube path pattern in which, with respect to axes A, B, C, D and E arranged in the longitudinal direction at the corners of a pentagram, in particular a regular pentagram, the tubular section extends along the points A1, A2, B2, B1, C1, C2, D2, D1, E1, E2, A2, A1, B1, B2, C2, C1, D1, D2, E2, E1, A1 . . . , counterclockwise in relation to points A1, B1, C1, D1 and E1 situated offset relative to the axes, and clockwise in relation to points A2, B2, C2, D2 and E2 situated offset relative to the axes or extends in mirror symmetry.

28. A mixer/heat exchanger having:
a fluid-carrying volume having a fluid inlet and a fluid outlet, and
a mixer/heat exchanger insert as claimed in claim 16,
wherein the mixer/heat exchanger insert extends into the fluid-carrying volume, with the result that a fluid flowing into the fluid-carrying volume through the fluid inlet is subject to a shear stress owing to the geometry of the mixer/heat exchanger insert before the inflowing fluid leaves the fluid-carrying volume through the fluid outlet.

29. The mixer/heat exchanger as claimed in claim 28, wherein the fluid-carrying volume has a constant clear cross-sectional area in the longitudinal direction of extent (L).

30. The mixer/heat exchanger as claimed in claim 28, wherein an envelope (E) of the mixer/heat exchanger insert as claimed in claim 16 has a clearance with respect to an inner wall of the fluid-carrying volume of the mixer/heat exchanger, into which the mixer/heat exchanger insert is to be introduced, which is at least a quarter of the tube diameter.
